(19) United States
(12) Patent Application Publication
(10) Pub. No.: US 2019/0023100 A1
(43) Pub. Date: Jan. 24, 2019

(54) Vehicle Air Conditioner

(71) Applicant: SANDEN AUTOMOTIVE CLIMATE SYSTEM CORPORATION, Isesaki-shi (JP)

(72) Inventors: Kenichi SUZUKI, Isesaki-shi (JP); Ryo MIYAKOSHI, Isesaki-shi (JP); Kohei YAMASHITA, Isesaki-shi (JP)

(21) Appl. No.: 16/077,165

(22) PCT Filed: Feb. 21, 2017
(86) PCT No.: PCT/JP2017/008041

§ 371 Date: Aug. 10, 2018

(30) Foreign Application Priority Data
Feb. 26, 2016 (JP) 2016-035691

(51) Int. Cl. B60H 1/00; B60H 1/22

(52) U.S. Cl. CPC B60H 1/00385; B60H 1/3207; B60H 1/2218

(57) ABSTRACT

Vehicle air conditioner avoids operation when short of refrigerant or oil due to backflow of refrigerant from an outdoor expansion valve to a radiator and which previously prevents lowering of air conditioning performance or deterioration of reliability. A first operation mode sends, to radiator 4, refrigerant discharged from compressor 2. A second operation mode shuts off outdoor expansion valve 6 and sends refrigerant directly into outdoor heat exchanger 7, passing the radiator and the outdoor expansion valve with bypass device 45. In the second operation mode, based on difference ΔPdc between pressures on outlet and inlet sides of the outdoor expansion valve 6, a controller controls a number of revolutions of compressor 2 so that pressure difference ΔPdc is not in excess of a predetermined reverse pressure limit ULΔPdcH of outdoor expansion valve 6.

### TECHNICAL FIELD

The present invention relates to an air conditioner of a heat pump system which conditions air of a vehicle interior, and more particularly, it relates to an air conditioner which is applicable to a hybrid car and an electric vehicle.

### BACKGROUND ART

To cope with enhancement of environmental problems in recent years, hybrid cars and electric vehicles have spread. As an air conditioning device which is applicable to such a vehicle, there has been developed an air conditioning device comprising a compressor to compress and discharge a refrigerant; an internal condenser disposed on the side of a vehicle interior to radiate heat from the refrigerant; an evaporator disposed on the side of the vehicle interior so that the refrigerant absorbs heat; an external condenser disposed outside the vehicle interior so that the refrigerant radiates heat or absorbs heat; a first expansion valve to expand the refrigerant which flows into this external condenser; a second expansion valve to expand the refrigerant which flows into the evaporator; a pipe which bypasses the internal condenser and the first expansion valve; and a first valve which switches between flowing the refrigerant discharged from the compressor to the internal condenser and directly flowing the refrigerant to the external condenser from the pipe, bypassing the internal condenser and the first expansion valve; and thus, in the above constitution, a heating mode, a dehumidifying mode and a cooling mode are switched among these modes; and the heating mode comprises flowing the refrigerant discharged from the compressor to the internal condenser by the first valve to radiate heat, depressurizing the radiated refrigerant by the first expansion valve, and absorbing heat in the external condenser; the dehumidifying mode comprises radiating heat from the refrigerant discharged from the compressor in the internal condenser by the first valve, depressurizing the radiated refrigerant by the second expansion valve, and absorbing heat in the evaporator; and the cooling mode comprises flowing the refrigerant discharged from the compressor to the external condenser by the first valve, bypassing the internal condenser and the first expansion valve, thereby radiating the heat, depressurizing in the second expansion valve, and absorbing heat in the evaporator (e.g., see Patent Document 1).

### CITATION LIST

### Patent Documents

Patent Document 1: Japanese Patent Application Publication No. 2013-23210

### SUMMARY OF THE INVENTION

### Problems to be Solved by the Invention

As described above, in Patent Document 1, there is a situation where a refrigerant is not sent to an internal condenser (a radiator in the present application) in a cooling mode. Specifically, a first expansion valve is closed, but a pressure on a discharge side of a compressor is higher than a pressure in the internal condenser, and hence a difference between a pressure on an outlet side of this first expansion valve and a pressure on an inlet side thereof increases. On the other hand, this type of expansion valve (the first expansion valve) has a reverse pressure limit. When the difference between the pressure on the outlet side and the pressure on the inlet side is in excess of this reverse pressure limit, the first expansion valve (an outdoor expansion valve in the present application) cannot resist the refrigerant and hence opens, and the refrigerant flows backward, flows into the internal condenser and is accumulated therein.

Thus, the refrigerant is accumulated in the internal condenser and is laid up therein for a long time. When an amount of the refrigerant increases, an amount of the refrigerant to be circulated in a refrigerant circuit decreases, and hence an air conditioning performance lowers. Furthermore, the refrigerant also includes lubricating oil, and hence there is also the problem that an amount of oil to return to the compressor (corresponding to a compressor of the present application) runs short, burning occurs, and damages are caused in the worst case.

The present invention has been developed to solve such conventional technical problems, and an object thereof is to provide a vehicle air conditioner which is capable of avoiding an operation in a state of being short of refrigerant or oil due to backflow of the refrigerant from an outdoor expansion valve to a radiator and is capable of previously preventing lowering of an air conditioning performance or deterioration of reliability.

### Means for Solving the Problems

A vehicle air conditioner of the invention includes a compressor to compress a refrigerant, an air flow passage through which air to be supplied to a vehicle interior flows, a radiator to let the refrigerant radiate heat, thereby heating the air to be supplied from the air flow passage to the vehicle interior, a heat absorber to let the refrigerant absorb heat, thereby cooling the air to be supplied from the air flow passage to the vehicle interior, an outdoor heat exchanger disposed outside the vehicle interior, an outdoor expansion valve to decompress the refrigerant flowing out from the radiator and flowing into the outdoor heat exchanger, a bypass device to send, to the outdoor heat exchanger, the refrigerant discharged from the compressor, passing the radiator and the outdoor expansion valve, and a control device, so that this control device switches between and executes a first operation mode to send, to the radiator, the refrigerant discharged from the compressor, and a second operation mode to shut off the outdoor expansion valve and send, directly into the outdoor heat exchanger, the refrigerant discharged from the compressor, passing the radiator and the outdoor expansion valve by the bypass device, and the vehicle air conditioner is characterized in that in the second operation mode, on the basis of a difference ΔPdc between a pressure on an outlet side of the outdoor expansion valve and a pressure on an inlet side thereof, the control device controls a number of revolution of the compressor so that the pressure difference ΔPdc is not in excess of a predetermined reverse pressure limit ULΔPdcH of the outdoor expansion valve.

The vehicle air conditioner of the invention of claim 2 is characterized in that in the above invention, the control device has a predetermined protection stopping value ULΔPdcA which is lower than the reverse pressure limit ULΔPdcH of the outdoor expansion valve, and a predetermined operation limiting value ULΔPdcB which is further lower than this protection stopping value ULΔPdcA, and in the second operation mode, the control device controls the number of revolution of the compressor so that the difference ΔPdc between the pressure on the outlet side of the outdoor expansion valve and the pressure on the inlet side thereof is prevented from being more than the operation limiting value ULΔPdcB, and when the pressure difference ΔPdc becomes the protection stopping value ULΔPdcA, the control device stops the compressor.

The vehicle air conditioner of the invention of claim 3 is characterized in that in the above invention, the control device has a predetermined lower limit limiting value ULΔPdcC which is further lower than the operation limiting value ULΔPdcB, and when starting the second operation mode, the control device controls the number of revolution of the compressor so that the difference ΔPdc between the pressure on the outlet side of the outdoor expansion valve and the pressure on the inlet side thereof is prevented from being more than the lower limit limiting value ULΔPdcC, and when the pressure difference ΔPdc is in excess of the lower limit limiting value ULΔPdcC, the control device gradually raises the lower limit limiting value ULΔPdcC toward the operation limiting value ULΔPdcB.

The vehicle air conditioner of the invention of claim 4 is characterized in that in the above invention, when changing the lower limit limiting value ULΔPdcC to the operation limiting value ULΔPdcB, the control device raises the value with a predetermined time constant of first-order lag which is previously determined.

The vehicle air conditioner of the invention of claim 5 is characterized in that in the above invention of claim 2 to claim 4 includes an auxiliary heating device to heat the air to be supplied from the air flow passage to the vehicle interior, the control device has a predetermined lower limit limiting value ULΔPdcC which is further lower than the operation limiting value ULΔPdcB, and when starting the second operation mode while generating heat in the auxiliary heating device, the control device controls the number of revolution of the compressor so that the difference ΔPdc between the pressure on the outlet side of the outdoor expansion valve and the pressure on the inlet side thereof is prevented from being more than the lower limit limiting value ULΔPdcC, and when starting the second operation mode without generating heat in the auxiliary heating device, the control device controls the number of revolution of the compressor so that the difference ΔPdc between the pressure on the outlet side of the outdoor expansion valve and the pressure on the inlet side thereof is prevented from being more than the operation limiting value ULΔPdcB.

The vehicle air conditioner of the invention of claim 6 is characterized in that each of the above inventions includes an auxiliary heating device to heat the air to be supplied from the air flow passage to the vehicle interior, and the control device has, as the first operation mode, one, any combination or all of a heating mode to send, to the radiator, the refrigerant discharged from the compressor, let the refrigerant radiate heat, decompress, in the outdoor expansion valve, the refrigerant from which the heat has been radiated, and let the refrigerant absorb heat in the outdoor heat exchanger, a dehumidifying and cooling mode to send, from the radiator to the outdoor heat exchanger, the refrigerant discharged from the compressor, let the refrigerant radiate heat in the radiator and the outdoor heat exchanger, decompress the refrigerant from which the heat has been radiated, and then let the refrigerant absorb heat in the heat absorber, and a cooling mode to send, from the radiator to the outdoor heat exchanger, the refrigerant discharged from the compressor, let the refrigerant radiate heat in the outdoor heat exchanger, decompress the refrigerant from which the heat has been radiated, and then let the refrigerant absorb heat in the heat absorber, and the control device has, as the second operation mode, one or both of a dehumidifying and heating mode to send, to the outdoor heat exchanger, the refrigerant discharged from the compressor, by the bypass device, let the refrigerant radiate heat, decompress the refrigerant from which the heat has been radiated, let the refrigerant absorb heat in the heat absorber, and generate heat in the auxiliary heating device, and a maximum cooling mode to send, to the outdoor heat exchanger, the refrigerant discharged from the compressor, by the bypass device, let the refrigerant radiate heat, decompress the refrigerant from which the heat has been radiated, and let the refrigerant absorb heat in the heat absorber.

### Advantageous Effect of the Invention

According to the present invention, a vehicle air conditioner includes a compressor to compress a refrigerant, an air flow passage through which air to be supplied to a vehicle interior flows, a radiator to let the refrigerant radiate heat, thereby heating the air to be supplied from the air flow passage to the vehicle interior, a heat absorber to let the refrigerant absorb heat, thereby cooling the air to be supplied from the air flow passage to the vehicle interior, an outdoor heat exchanger disposed outside the vehicle interior, an outdoor expansion valve to decompress the refrigerant flowing out from the radiator and flowing into the outdoor heat exchanger, a bypass device to send, to the outdoor heat exchanger, the refrigerant discharged from the compressor, passing the radiator and the outdoor expansion valve, and a control device, so that this control device switches between and executes a first operation mode to send, to the radiator, the refrigerant discharged from the compressor, and a second operation mode to shut off the outdoor expansion valve and send, directly into the outdoor heat exchanger, the refrigerant discharged from the compressor, passing the radiator and the outdoor expansion valve by the bypass device, and in the vehicle air conditioner, in the second operation mode, on the basis of a difference ΔPdc between a pressure on an outlet side of the outdoor expansion valve and a pressure on an inlet side thereof, the control device controls a number of revolution of the compressor so that pressure difference ΔPdc is not in excess of a predetermined reverse pressure limit ULΔPdcH of the outdoor expansion valve. Consequently, in the second operation mode to close the outdoor expansion valve, it is possible to prevent or inhibit the disadvantage that the difference ΔPdc between the pressure on the outlet side of the outdoor expansion valve and the pressure on the inlet side thereof is in excess of the reverse pressure limit ULΔPdcH of the outdoor expansion valve, the outdoor expansion valve opens and the refrigerant flows backward into the radiator.

In consequence, in the second operation mode in which the refrigerant is not sent to the radiator, it is possible to previously avoid the disadvantage that a large amount of refrigerant is accumulated in the radiator to decrease an amount of the refrigerant to be circulated and that an air conditioning performance lowers. Furthermore, it is possible to avoid an operation in a state of being short of oil. Therefore, it is also possible to previously prevent the disadvantage that the compressor is damaged, and it is possible to achieve a highly reliable and comfortable air conditioning operation.

In this case, as in the invention of claim 2, there are set, to the control device, a predetermined protection stopping value ULΔPdcA which is lower than the reverse pressure limit ULΔPdcH of the outdoor expansion valve, and a predetermined operation limiting value ULΔPdcB which is further lower than this protection stopping value ULΔPdcA, and in the second operation mode, the control device controls the number of revolution of the compressor so that the difference ΔPdc between the pressure on the outlet side of the outdoor expansion valve and the pressure on the inlet side thereof is prevented from being more than the operation limiting value ULΔPdcB. Furthermore, when the pressure difference ΔPdc becomes the protection stopping value ULΔPdcA, the control device stops the compressor. Consequently, it is possible to accurately prevent or inhibit the disadvantage that the difference ΔPdc between the pressure on the outlet side of the outdoor expansion valve and the pressure on the inlet side thereof is in excess of the reverse pressure limit ULΔPdcH, the outdoor expansion valve opens and the refrigerant flows backward into the radiator.

Furthermore, as in the invention of claim 3, there is set, to the control device, a predetermined lower limit limiting value ULΔPdcC which is further lower than the operation limiting value ULΔPdcB, and when starting the second operation mode, the control device controls the number of revolution of the compressor so that the difference ΔPdc between the pressure on the outlet side of the outdoor expansion valve and the pressure on the inlet side thereof is prevented from being more than the lower limit limiting value ULΔPdcC. Additionally, when the pressure difference ΔPdc is in excess of the lower limit limiting value ULΔPdcC, the control device gradually raises the lower limit limiting value ULΔPdcC toward the operation limiting value ULΔPdcB. Consequently, it is possible to previously avoid the disadvantage that the pressure difference ΔPdc enlarges due to so-called overshoot, and it is possible to further securely prevent the backflow of the refrigerant into the radiator.

In this case, as in the invention of claim 4, when changing the lower limit limiting value ULΔPdcC to the operation limiting value ULΔPdcB, the control device raises the value with a predetermined time constant of first-order lag which is previously determined. Consequently, it is possible to further accurately eliminate occurrence of the overshoot.

Furthermore, when an auxiliary heating device to heat the air to be supplied from the air flow passage to the vehicle interior is disposed as in the invention of claim 5, there is similarly set, to the control device, a predetermined lower limit limiting value ULΔPdcC which is further lower than the operation limiting value ULΔPdcB, and when starting the second operation mode while generating heat in the auxiliary heating device, the control device controls the number of revolution of the compressor so that the difference ΔPdc between the pressure on the outlet side of the outdoor expansion valve and the pressure on the inlet side thereof is prevented from being more than the lower limit limiting value ULΔPdcC. When starting the second operation mode without generating heat in the auxiliary heating device, the control device controls the number of revolution of the compressor so that the difference ΔPdc between the pressure on the outlet side of the outdoor expansion valve and the pressure on the inlet side thereof is prevented from being more than the operation limiting value ULΔPdcB. Consequently, in the second operation mode to generate heat in the auxiliary heating device, i.e., in a dehumidifying and heating mode described in claim 6, the number of revolution of the compressor is limited in an earlier stage, thereby securely preventing the backflow of the refrigerant into the radiator due to enlargement of the pressure difference ΔPdc, while in the second operation mode in which heat is not generated in the auxiliary heating device, i.e., in a maximum cooling mode described in claim 6, the limit of the number of revolution of the compressor is inhibited, thereby enabling prevention of deterioration of comfortability due to lowering of a cooling capability of the vehicle interior.

Additionally, as in the invention of claim 6, there is disposed an auxiliary heating device to heat the air to be supplied from the air flow passage to the vehicle interior, the control device has, as the first operation mode, one, any combination or all of a heating mode to send, to the radiator, the refrigerant discharged from the compressor, let the refrigerant radiate heat, decompress, in the outdoor expansion valve, the refrigerant from which the heat has been radiated, and let the refrigerant absorb heat in the outdoor heat exchanger, a dehumidifying and cooling mode to send, from the radiator to the outdoor heat exchanger, the refrigerant discharged from the compressor, let the refrigerant radiate heat in the radiator and the outdoor heat exchanger, decompress the refrigerant from which the heat has been radiated, and then let the refrigerant absorb heat in the heat absorber, and a cooling mode to send, from the radiator to the outdoor heat exchanger, the refrigerant discharged from the compressor, let the refrigerant radiate heat in the outdoor heat exchanger, decompress the refrigerant from which the heat has been radiated, and then let the refrigerant absorb heat in the heat absorber, and the control device has, as the second operation mode, one or both of a dehumidifying and heating mode to send, to the outdoor heat exchanger, the refrigerant discharged from the compressor, by the bypass device, let the refrigerant radiate heat, decompress the refrigerant from which the heat has been radiated, let the refrigerant absorb heat in the heat absorber, and generate heat in the auxiliary heating device, and a maximum cooling mode to send, to the outdoor heat exchanger, the refrigerant discharged from the compressor, by the bypass device, let the refrigerant radiate heat, decompress the refrigerant from which the heat has been radiated, and let the refrigerant absorb heat in the heat absorber. Consequently, the control device switches between the heating mode to be performed by sending the refrigerant to the radiator, the dehumidifying and heating mode to be performed without sending the refrigerant to the radiator, the dehumidifying and cooling mode and the cooling mode to be performed by sending the refrigerant to the radiator, the maximum cooling mode to be performed without sending the refrigerant to the radiator, and others, so that it is possible to achieve comfortable air conditioning of the vehicle interior.

### BRIEF DESCRIPTION OF THE DRAWINGS

FIG. 1 is a constitutional view of a vehicle air conditioner of one embodiment to which the present invention is applied (a heating mode, a dehumidifying and heating mode, a dehumidifying and cooling mode and a cooling mode);

FIG. 2 is a block diagram of an electric circuit of a controller of the vehicle air conditioner of FIG. 1;

FIG. 3 is a constitutional view at the time of a MAX cooling mode (the maximum cooling mode) of the vehicle air conditioner of FIG. 1;

FIG. 4 is a control block diagram concerned with compressor control in the MAX cooling mode of the controller of FIG. 2;

FIG. 5 is an explanatory view of a limiting/protecting operation based on a difference ΔPdc between a pressure on an outlet side of an outdoor expansion valve and a pressure on an inlet side thereof by the controller of FIG. 2;

FIG. 6 is an explanatory view of another limiting/protecting operation based on the difference ΔPdc between the pressure on the outlet side of the outdoor expansion valve and the pressure on the inlet side thereof by the controller of FIG. 2;

FIG. 7 is a view to explain the limiting/protecting operation of FIG. 6 in detail;

FIG. 8 is an explanatory view of still another limiting/protecting operation based on the difference ΔPdc between the pressure on the outlet side of the outdoor expansion valve and the pressure on the inlet side thereof by the controller of FIG. 2; and

FIG. 9 is a timing chart to explain control on startup in the MAX cooling mode by the controller of FIG. 2.

### MODE FOR CARRYING OUT THE INVENTION

Hereinafter, description will be made as to embodiments of the present invention in detail with reference to the drawings.

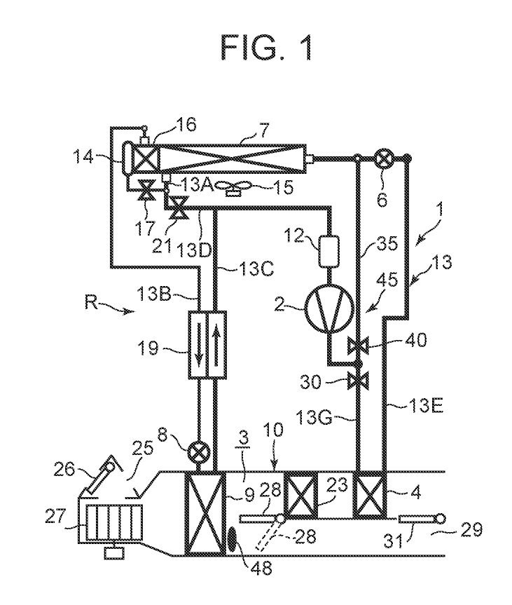

FIG. 1 shows a constitutional view of a vehicle air conditioner 1 of one embodiment of the present invention. A vehicle of the embodiment to which the present invention is applied is an electric vehicle (EV) in which an engine (an internal combustion engine) is not mounted, and runs with an electric motor for running which is driven by power charged in a battery (which is not shown in the drawing), and the vehicle air conditioner 1 of the present invention is also driven by the power of the battery. Specifically, in the electric vehicle which is not capable of performing heating by engine waste heat, the vehicle air conditioner 1 of the embodiment performs a heating mode by a heat pump operation in which a refrigerant circuit is used, and furthermore, the conditioner selectively executes respective operation modes of a dehumidifying and heating mode, a dehumidifying and cooling mode, a cooling mode, and a MAX cooling mode (the maximum cooling mode).

It is to be noted that the vehicle is not limited to the electric vehicle, and the present invention is also effective for a so-called hybrid car in which the engine is used together with the electric motor for running. Furthermore, needless to say, the present invention is also applicable to a usual car which runs with the engine.

The vehicle air conditioner 1 of the embodiment performs air conditioning (heating, cooling, dehumidifying, and ventilation) of a vehicle interior of the electric vehicle, and there are successively connected, by a refrigerant pipe 13, an electric type of compressor 2 to compress a refrigerant, a radiator 4 disposed in an air flow passage 3 of an HVAC unit 10 in which vehicle interior air passes and circulates, to send inside the high-temperature high-pressure refrigerant discharged from the compressor 2 via a refrigerant pipe 13G and let this refrigerant radiate heat in the vehicle interior, an outdoor expansion valve 6 constituted of an electric valve which decompresses and expands the refrigerant during the heating, an outdoor heat exchanger 7 which is disposed outside the vehicle interior and performs heat exchange between the refrigerant and outdoor air to function as the radiator during the cooling and to function as an evaporator during the heating, an indoor expansion valve 8 constituted of an electric valve to decompress and expand the refrigerant, a heat absorber 9 disposed in the air flow passage 3 to let the refrigerant absorb or radiate heat from interior and exterior of the vehicle during the cooling and during the dehumidifying, an accumulator 12, and others, thereby constituting a refrigerant circuit R.

Furthermore, this refrigerant circuit R is charged with a predetermined amount of refrigerant and a predetermined amount of lubricating oil. It is to be noted that an outdoor blower 15 is provided in the outdoor heat exchanger 7. The outdoor blower 15 forcibly sends the outdoor air through the outdoor heat exchanger 7 to perform the heat exchange between the outdoor air and the refrigerant, whereby the outdoor air passes through the outdoor heat exchanger 7 also during stopping of the vehicle (i.e., a velocity is 0 km/h).

Additionally, the outdoor heat exchanger 7 has a receiver drier portion 14 and a subcooling portion 16 successively on a refrigerant downstream side, a refrigerant pipe 13A extending out from the outdoor heat exchanger 7 is connected to the receiver drier portion 14 via a solenoid valve 17 to be opened during the cooling, and a refrigerant pipe 13B on an outlet side of the subcooling portion 16 is connected to an inlet side of the heat absorber 9 via the indoor expansion valve 8. It is to be noted that the receiver drier portion 14 and the subcooling portion 16 structurally constitute a part of the outdoor heat exchanger 7.

In addition, the refrigerant pipe 13B between the subcooling portion 16 and the indoor expansion valve 8 is disposed in a heat exchange relation with a refrigerant pipe 13C on an outlet side of the heat absorber 9, and both the pipes constitute an internal heat exchanger 19. In consequence, the refrigerant flowing into the indoor expansion valve 8 through the refrigerant pipe 13B is cooled (subcooled) by the low-temperature refrigerant flowing out from the heat absorber 9.

Furthermore, the refrigerant pipe 13A extending out from the outdoor heat exchanger 7 branches to a refrigerant pipe 13D, and this branching refrigerant pipe 13D communicates and connects with the refrigerant pipe 13C on a downstream side of the internal heat exchanger 19 via a solenoid valve 21 to be opened during the heating. The refrigerant pipe 13C is connected to the accumulator 12, and the accumulator 12 is connected to a refrigerant suction side of the compressor 2. Additionally, a refrigerant pipe 13E on an outlet side of the radiator 4 is connected to an inlet side of the outdoor heat exchanger 7 via the outdoor expansion valve 6.

In addition, a solenoid valve 30 (constituting a flow channel changing device) to be closed during the dehumidifying and heating and MAX cooling described later is disposed in the refrigerant pipe 13G between a discharge side of the compressor 2 and an inlet side of the radiator 4. In this case, the refrigerant pipe 13G branches to a bypass pipe 35 on an upstream side of the solenoid valve 30, and this bypass pipe 35 communicates and connects with the refrigerant pipe 13E on a downstream side of the outdoor expansion valve 6 via a solenoid valve 40 (this also constitutes the flow channel changing device) which is to be opened during the dehumidifying and heating and MAX cooling. The bypass pipe 35, the solenoid valve 30 and the solenoid valve 40 constitute a bypass device 45 in the present invention.

Thus, the bypass pipe 35, the solenoid valve 30 and the solenoid valve 40 constitute the bypass device 45, so that it is possible to smoothly change from the dehumidifying and heating mode or the MAX cooling mode to send, directly into the outdoor heat exchanger 7, the refrigerant discharged from the compressor 2 as described later, to the heating mode, the dehumidifying and cooling mode or the cooling mode to send, into the radiator 4, the refrigerant discharged from the compressor 2.

Furthermore, in the air flow passage 3 on an air upstream side of the heat absorber 9, respective suction ports such as an outdoor air suction port and an indoor air suction port are formed (represented by a suction port 25 in FIG. 1), and in the suction port 25, a suction changing damper 26 is disposed to change the air to be introduced into the air flow passage 3 to indoor air which is air of the vehicle interior (an indoor air circulating mode) and outdoor air which is air outside the vehicle interior (an outdoor air introducing mode). Furthermore, on an air downstream side of the suction changing damper 26, an indoor blower (a blower fan) 27 is disposed to supply the introduced indoor or outdoor air to the air flow passage 3.

Additionally, in FIG. 1, reference numeral 23 denotes an auxiliary heater as an auxiliary heating device disposed in the vehicle air conditioner 1 of the embodiment. The auxiliary heater 23 of the embodiment is constituted of a PTC heater which is an electric heater, and disposed in the air flow passage 3 on an air upstream side of the radiator 4 to the flow of the air in the air flow passage 3. Then, when the auxiliary heater 23 is energized to generate heat, the air in the air flow passage 3 which flows into the radiator 4 through the heat absorber 9 is heated. That is, the auxiliary heater 23 becomes a so-called heater core to perform or complement the heating of the vehicle interior.

Furthermore, in the air flow passage 3 on an air upstream side of the auxiliary heater 23, an air mix damper 28 is disposed to adjust a degree at which the air (the indoor or outdoor air) in the air flow passage 3, flowing into the air flow passage 3 and passed through the heat absorber 9, passes through the auxiliary heater 23 and the radiator 4. Further in the air flow passage 3 on an air downstream side of the radiator 4, there is formed each outlet (represented by an outlet 29 in FIG. 1) of foot, vent or defroster, and in the outlet 29, an outlet changing damper 31 is disposed to execute changing control of blowing of the air from each outlet mentioned above.

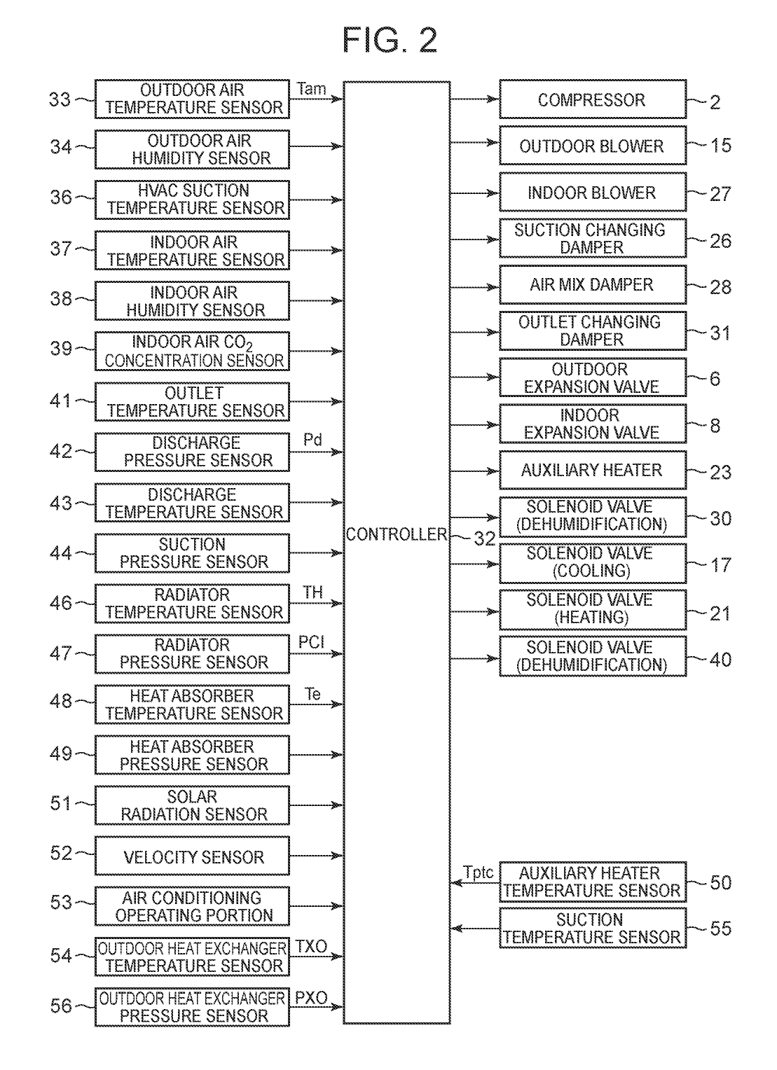

Next, in FIG. 2, reference numeral 32 denotes a controller (ECU) as a control device constituted of a microcomputer which is an example of a computer including a processor, and an input of the controller 32 is connected to respective outputs of an outdoor air temperature sensor 33 which detects an outdoor air temperature (Tam) of the vehicle, an outdoor air humidity sensor 34 which detects an outdoor air humidity, an HVAC suction temperature sensor 36 which detects a temperature of the air to be sucked from the suction port 25 to the air flow passage 3, an indoor air temperature sensor 37 which detects a temperature of the air of the vehicle interior (the indoor air), an indoor air humidity sensor 38 which detects a humidity of the air of the vehicle interior, an indoor air CO₂ concentration sensor 39 which detects a carbon dioxide concentration of the vehicle interior, an outlet temperature sensor 41 which detects a temperature of the air to be blown out from the outlet 29 to the vehicle interior, a discharge pressure sensor 42 which detects a pressure (a discharge pressure Pd) of the refrigerant discharged from the compressor 2, a discharge temperature sensor 43 which detects a temperature of the refrigerant discharged from the compressor 2, a suction pressure sensor 44 which detects a pressure of the refrigerant to be sucked into the compressor 2, a suction temperature sensor 55 which detects a temperature of the refrigerant to be sucked into the compressor 2, a radiator temperature sensor 46 which detects a temperature of the radiator 4 (the temperature of the air passed through the radiator 4 or the temperature of the radiator 4 itself: a radiator temperature TH), a radiator pressure sensor 47 which detects a refrigerant pressure of the radiator 4 (the pressure of the refrigerant in the radiator 4 or immediately after the refrigerant flows out from the radiator 4: a radiator pressure PCI), a heat absorber temperature sensor 48 which detects a temperature of the heat absorber 9 (the temperature of the air passed through the heat absorber 9 or the temperature of the heat absorber 9 itself: a heat absorber temperature Te), a heat absorber pressure sensor 49 which detects a refrigerant pressure of the heat absorber 9 (the pressure of the refrigerant in the heat absorber 9 or immediately after the refrigerant flows out from the heat absorber 9), a solar radiation sensor 51 of, e.g., a photo sensor system to detect a solar radiation amount into the vehicle, a velocity sensor 52 to detect a moving speed (a velocity) of the vehicle, an air conditioning operating portion 53 to set the changing of a predetermined temperature or the switching between operation modes, an outdoor heat exchanger temperature sensor 54 which detects a temperature of the outdoor heat exchanger 7 (the temperature immediately after the refrigerant flows out from the outdoor heat exchanger 7, or the temperature of the outdoor heat exchanger 7 itself: an outdoor heat exchanger temperature TXO), and an outdoor heat exchanger pressure sensor 56 which detects a refrigerant pressure of the outdoor heat exchanger 7 (the pressure of the refrigerant in the outdoor heat exchanger 7 or immediately after the refrigerant flows out from the outdoor heat exchanger 7: an outdoor heat exchanger pressure PXO). Furthermore, the input of the controller 32 is further connected to an output of an auxiliary heater temperature sensor 50 which detects a temperature of the auxiliary heater 23 (the temperature immediately after the air is heated by the auxiliary heater 23 or the temperature of the auxiliary heater 23 itself: an auxiliary heater temperature Tptc).

On the other hand, an output of the controller 32 is connected to the compressor 2, the outdoor blower 15, the indoor blower (the blower fan) 27, the suction changing damper 26, the air mix damper 28, the outlet changing damper 31, the outdoor expansion valve 6, the indoor expansion valve 8, the auxiliary heater 23, and the respective solenoid valves, i.e., the solenoid valve 30 (for the dehumidifying), the solenoid valve 17 (for the cooling), the solenoid valve 21 (for the heating) and the solenoid valve 40 (also for the dehumidifying). Then, the controller 32 controls these components on the basis of the outputs of the respective sensors and the setting input by the air conditioning operating portion 53.

Next, description will be made as to an operation of the vehicle air conditioner 1 of the embodiment having the above constitution. In the embodiment, the controller 32 switches between and executes the respective operation modes of the heating mode, the dehumidifying and heating mode, the dehumidifying and cooling mode, the cooling mode and the MAX cooling mode (the maximum cooling mode). Description will initially be made as to a flow of the refrigerant and an outline of control in each operation mode.

(1) Heating Mode

When the heating mode is selected by the controller 32 (an automatic mode) or a manual operation to the air conditioning operating portion 53 (a manual mode), the controller 32 opens the solenoid valve 21 (for the heating) and closes the solenoid valve 17 (for the cooling). Furthermore, the controller opens the solenoid valve 30 (for the dehumidifying) and closes the solenoid valve 40 (for the dehumidifying).

Then, the controller operates the compressor 2 and the respective blowers 15 and 27, and the air mix damper 28 has a state of sending, to the auxiliary heater 23 and the radiator 4, all the air in the air flow passage 3 that is blown out from the indoor blower 27 and passed through the heat absorber 9 as shown by a broken line in FIG. 1. In consequence, a high-temperature high-pressure gas refrigerant discharged from the compressor 2 flows into the radiator 4 through the solenoid valve 30 and the refrigerant pipe 13G. The air in the air flow passage 3 passes through the radiator 4, and hence the air in the air flow passage 3 heats by the high-temperature refrigerant in the radiator 4 (in the auxiliary heater 23 and the radiator 4, when the auxiliary heater 23 operates), whereas the refrigerant in the radiator 4 has the heat taken by the air and is cooled to condense and liquefy.

The refrigerant liquefied in the radiator 4 flows out from the radiator 4 and then flows through the refrigerant pipe 13E to reach the outdoor expansion valve 6. The refrigerant flowing into the outdoor expansion valve 6 is decompressed therein, and then flows into the outdoor heat exchanger 7. The refrigerant flowing into the outdoor heat exchanger 7 evaporates, and the heat is pumped up from the outdoor air passed by running or the outdoor blower 15. In other words, the refrigerant circuit R functions as a heat pump. Then, the low-temperature refrigerant flowing out from the outdoor heat exchanger 7 flows through the refrigerant pipe 13A, the solenoid valve 21 and the refrigerant pipe 13D, and flows from the refrigerant pipe 13C into the accumulator 12 to perform gas-liquid separation, and the gas refrigerant is sucked into the compressor 2, thereby repeating this circulation. The air heated in the radiator 4 (in the auxiliary heater 23 and the radiator 4, when the auxiliary heater 23 operates) is blown out from the outlet 29, thereby performing the heating of the vehicle interior.

The controller 32 calculates a target radiator pressure PCO (a target value of the radiator pressure PCI) from a target radiator temperature TCO (a target value of the radiator temperature TH) calculated from an after-mentioned target outlet temperature TAO, and controls a number of revolution of the compressor 2 on the basis of the target radiator pressure PCO and the refrigerant pressure of the radiator 4 which is detected by the radiator pressure sensor 47 (the radiator pressure PCI that is a high pressure of the refrigerant circuit R). Furthermore, the controller 32 controls a valve position of the outdoor expansion valve 6 on the basis of the temperature (the radiator temperature TH) of the radiator 4 which is detected by the radiator temperature sensor 46 and the radiator pressure PCI detected by the radiator pressure sensor 47, and controls a subcool degree SC of the refrigerant in an outlet of the radiator 4. The target radiator temperature TCO is basically TCO=TAO, but a predetermined limit of controlling is provided.

Furthermore, in this heating mode, when a heating capability by the radiator 4 runs short to a heating capability required for vehicle interior air conditioning, the controller 32 controls the energization of the auxiliary heater 23 to complement the shortage by the heat generation of the auxiliary heater 23. In consequence, comfortable vehicle interior heating is achieved, and frosting of the outdoor heat exchanger 7 is inhibited. At this time, the auxiliary heater 23 is disposed on the air upstream side of the radiator 4, and hence the air flowing through the air flow passage 3 is passed through the auxiliary heater 23 before the radiator 4.

Here, if the auxiliary heater 23 is disposed on the air downstream side of the radiator 4 and when the auxiliary heater 23 is constituted of the PCT heater as in the embodiment, the temperature of the air flowing into the auxiliary heater 23 rises due to the radiator 4. Therefore, a resistance value of the PTC heater increases, and a current value decreases to also decrease an amount of heat to be generated, but the auxiliary heater 23 is disposed on the air upstream side of the radiator 4, so that it is possible to sufficiently exert a capability of the auxiliary heater 23 constituted of the PTC heater as in the embodiment.

(2) Dehumidifying and Heating Mode

Next, in the dehumidifying and heating mode, the controller 32 opens the solenoid valve 17 and closes the solenoid valve 21. Furthermore, the controller closes the solenoid valve 30, opens the solenoid valve 40, and adjusts a valve position of the outdoor expansion valve 6 to a shutoff position. Then, the controller operates the compressor 2 and the respective blowers 15 and 27. As shown by the broken line in FIG. 1, the air mix damper 28 achieves a state of sending, to the auxiliary heater 23 and the radiator 4, all the air in the air flow passage 3 that is blown out from the indoor blower 27 and passed through the heat absorber 9.

In consequence, the high-temperature high-pressure gas refrigerant discharged from the compressor 2 to the refrigerant pipe 13G flows into the bypass pipe 35 without flowing toward the radiator 4, and flows through the solenoid valve 40 to reach the refrigerant pipe 13E on the downstream side of the outdoor expansion valve 6. At this time, the outdoor expansion valve 6 is shut off, and hence the refrigerant flows into the outdoor heat exchanger 7. The refrigerant flowing into the outdoor heat exchanger 7 is cooled by running therein or the outdoor air passed through the outdoor blower 15, to condense. The refrigerant flowing out from the outdoor heat exchanger 7 flows from the refrigerant pipe 13A through the solenoid valve 17 successively into the receiver drier portion 14 and the subcooling portion 16. Here, the refrigerant is subcooled.

The refrigerant flowing out from the subcooling portion 16 of the outdoor heat exchanger 7 enters the refrigerant pipe 13B and flows through the internal heat exchanger 19 to reach the indoor expansion valve 8. In the indoor expansion valve 8, the refrigerant is decompressed, and then flows into the heat absorber 9 to evaporate. By a heat absorbing operation at this time, the air blown out from the indoor blower 27 is cooled, and water in the air coagulates to adhere to the heat absorber 9. Therefore, the air in the air flow passage 3 is cooled and dehumidified. The refrigerant evaporated in the heat absorber 9 flows through the internal heat exchanger 19 and the refrigerant pipe 13C to reach the accumulator 12, and flows therethrough to be sucked into the compressor 2, thereby repeating the circulation.

At this time, the valve position of the outdoor expansion valve 6 is adjusted to the shutoff position, so that it is possible to inhibit or prevent the disadvantage that the refrigerant discharged from the compressor 2 flows from the outdoor expansion valve 6 back into the radiator 4. Consequently, it is possible to inhibit or eliminate decrease of an amount of the refrigerant to be circulated, thereby acquiring the air conditioning capability. Furthermore, in this dehumidifying and heating mode, the controller 32 energizes the auxiliary heater 23 to generate heat. Consequently, the air cooled and dehumidified in the heat absorber 9 is further heated in a process of passing the auxiliary heater 23, and hence a temperature rises, thereby performing the dehumidifying and heating of the vehicle interior.

The controller 32 controls the number of revolution of the compressor 2 on the basis of the temperature (the heat absorber temperature Te) of the heat absorber 9 which is detected by the heat absorber temperature sensor 48 and a target heat absorber temperature TEO that is a target value of the heat absorber temperature, and the controller controls the energization (the heat generation) of the auxiliary heater 23 on the basis of the auxiliary heater temperature Tptc detected by the auxiliary heater temperature sensor 50 and the above-mentioned target radiator temperature TCO. Consequently, the drop of the temperature of the air blown out from the outlet 29 to the vehicle interior is accurately prevented by the heating of the auxiliary heater 23, while appropriately performing the cooling and dehumidifying of the air in the heat absorber 9.

In consequence, the temperature of the air blown out to the vehicle interior can be controlled at an appropriate heating temperature while dehumidifying the air, and it is possible to achieve comfortable and efficient dehumidifying and heating of the vehicle interior. Furthermore, as described above, in the dehumidifying and heating mode, the air mix damper 28 has a state of sending, through the auxiliary heater 23 and the radiator 4, all the air in the air flow passage 3. Therefore, the air passed through the heat absorber 9 is efficiently heated by the auxiliary heater 23, thereby improving energy saving properties, and controllability of the air conditioning for the dehumidifying and heating can improve.

It is to be noted that the auxiliary heater 23 is disposed on the air upstream side of the radiator 4, and hence the air heated by the auxiliary heater 23 passes through the radiator 4. However, in this dehumidifying and heating mode, the refrigerant does not flow through the radiator 4, and hence it is possible to eliminate the disadvantage that heat is absorbed, by the radiator 4, from the air heated by the auxiliary heater 23. Specifically, it is possible to inhibit the temperature drop of the air blown out to the vehicle interior by the radiator 4, and a coefficient of performance (COP) improves.

(3) Dehumidifying and Cooling Mode

Next, in the dehumidifying and cooling mode, the controller 32 opens the solenoid valve 17 and closes the solenoid valve 21. The controller also opens the solenoid valve 30 and closes the solenoid valve 40. Then, the controller operates the compressor 2 and the respective blowers 15 and 27, and the air mix damper 28 has the state of sending, through the auxiliary heater 23 and the radiator 4, all the air in the air flow passage 3 that is blown out from the indoor blower 27 and passed through the heat absorber 9. Consequently, the high-temperature high-pressure gas refrigerant discharged from the compressor 2 flows through the solenoid valve 30 and flows from the refrigerant pipe 13G into the radiator 4. The air in the air flow passage 3 passes through the radiator 4, and hence the air in the air flow passage 3 is heated by the high-temperature refrigerant in the radiator 4, whereas the refrigerant in the radiator 4 has the heat taken by the air and is cooled to condense and liquefy.

The refrigerant flowing out from the radiator 4 flows through the refrigerant pipe 13E to reach the outdoor expansion valve 6, and flows through the outdoor expansion valve 6 controlled to slightly open, to flow into the outdoor heat exchanger 7. The refrigerant flowing into the outdoor heat exchanger 7 is cooled by the running therein or the outdoor air passed through the outdoor blower 15, to condense. The refrigerant flowing out from the outdoor heat exchanger 7 flows from the refrigerant pipe 13A through the solenoid valve 17 to successively flow into the receiver drier portion 14 and the subcooling portion 16. Here, the refrigerant is subcooled.

The refrigerant flowing out from the subcooling portion 16 of the outdoor heat exchanger 7 enters the refrigerant pipe 13B and flows through the internal heat exchanger 19 to reach the indoor expansion valve 8. The refrigerant is decompressed in the indoor expansion valve 8 and then flows into the heat absorber 9 to evaporate. The water in the air blown out from the indoor blower 27 coagulates to adhere to the heat absorber 9 by the heat absorbing operation at this time, and hence the air is cooled and dehumidified.

The refrigerant evaporated in the heat absorber 9 flows through the internal heat exchanger 19 and the refrigerant pipe 13C to reach the accumulator 12, and flows therethrough to be sucked into the compressor 2, thereby repeating this circulation. In this dehumidifying and cooling mode, the controller 32 does not energize the auxiliary heater 23, and hence the air cooled and dehumidified in the heat absorber 9 is reheated in the process of passing the radiator 4 (a radiation capability is lower than that during the heating), thereby performing the dehumidifying and cooling of the vehicle interior.

The controller 32 controls the number of revolution of the compressor 2 on the basis of the temperature of the heat absorber 9 (the heat absorber temperature Te) which is detected by the heat absorber temperature sensor 48, also controls the valve position of the outdoor expansion valve 6 on the basis of the above-mentioned high pressure of the refrigerant circuit R, and controls the refrigerant pressure of the radiator 4 (the radiator pressure PCI).

(4) Cooling Mode

Next, in the cooling mode, the controller 32 adjusts the valve position of the outdoor expansion valve 6 to a fully opened position in the above state of the dehumidifying and cooling mode. It is to be noted that the controller 32 controls the air mix damper 28 to adjust a ratio at which the air in the air flow passage 3, blown out from the indoor blower 27 and passed through the heat absorber 9, passes through the auxiliary heater 23 and the radiator 4 as shown by a solid line in FIG. 1. Furthermore, the controller 32 does not energize the auxiliary heater 23.

In consequence, the high-temperature high-pressure gas refrigerant discharged from the compressor 2 flows through the solenoid valve 30 and flows from the refrigerant pipe 13G into the radiator 4, and the refrigerant flowing out from the radiator 4 flows through the refrigerant pipe 13E to reach the outdoor expansion valve 6. At this time, the outdoor expansion valve 6 is fully opened, and hence the refrigerant passes the outdoor expansion valve to flow into the outdoor heat exchanger 7 as it is, in which the refrigerant is cooled by the running therein or the outdoor air passed through the outdoor blower 15, to condense and liquefy. The refrigerant flowing out from the outdoor heat exchanger 7 flows from the refrigerant pipe 13A through the solenoid valve 17 to successively flow into the receiver drier portion 14 and the subcooling portion 16. Here, the refrigerant is subcooled.

The refrigerant flowing out from the subcooling portion 16 of the outdoor heat exchanger 7 enters the refrigerant pipe 13B and flows through the internal heat exchanger 19 to reach the indoor expansion valve 8. The refrigerant is decompressed in the indoor expansion valve 8 and then flows into the heat absorber 9 to evaporate. By the heat absorbing operation at this time, the air blown out from the indoor blower 27 is cooled. Furthermore, the water in the air coagulates to adhere to the heat absorber 9.

The refrigerant evaporated in the heat absorber 9 flows through the internal heat exchanger 19 and the refrigerant pipe 13C to reach the accumulator 12, and flows therethrough to be sucked into the compressor 2, thereby repeating this circulation. The air cooled and dehumidified in the heat absorber 9 is blown out from the outlet 29 to the vehicle interior (a part of the air passes the radiator 4 to perform heat exchange), thereby performing the cooling of the vehicle interior. In this cooling mode, the controller 32 also controls the number of revolution of the compressor 2 on the basis of the temperature of the heat absorber 9 (the heat absorber temperature Te) which is detected by the heat absorber temperature sensor 48 and the target heat absorber temperature TEO that is the target value of the heat absorber temperature.

(5) MAX Cooling Mode (Maximum Cooling Mode)

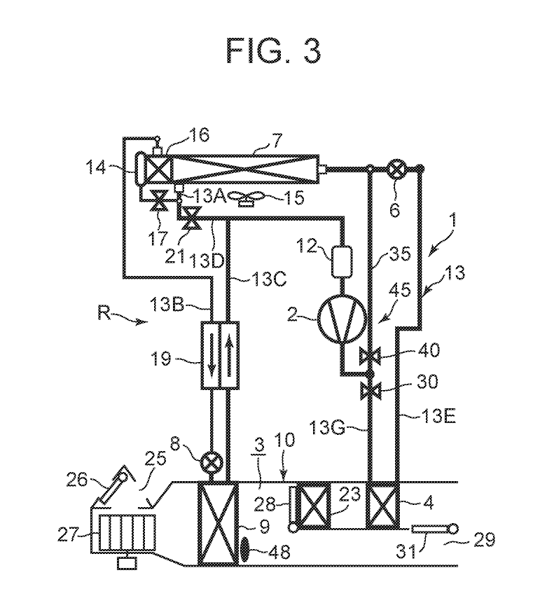

Next, in the MAX cooling mode that is the maximum cooling mode, the controller 32 opens the solenoid valve 17 and closes the solenoid valve 21. The controller also closes the solenoid valve 30, opens the solenoid valve 40, and adjusts the valve position of the outdoor expansion valve 6 to the shutoff position. Then, the controller operates the compressor 2 and the respective blowers 15 and 27, and the air mix damper 28 has a state where the air in the air flow passage 3 does not pass through the auxiliary heater 23 and the radiator 4 as shown in FIG. 3. However, even when the air slightly passes, there are not any problems. Furthermore, the controller 32 does not energize the auxiliary heater 23.

In consequence, the high-temperature high-pressure gas refrigerant discharged from the compressor 2 to the refrigerant pipe 13G flows into the bypass pipe 35 without flowing toward the radiator 4, and flows through the solenoid valve 40 to reach the refrigerant pipe 13E on the downstream side of the outdoor expansion valve 6. At this time, the outdoor expansion valve 6 is shut off, and hence the refrigerant flows into the outdoor heat exchanger 7. The refrigerant flowing into the outdoor heat exchanger 7 is cooled by running therein or the outdoor air passed through the outdoor blower 15, to condense. The refrigerant flowing out from the outdoor heat exchanger 7 flows from the refrigerant pipe 13A through the solenoid valve 17 successively into the receiver drier portion 14 and the subcooling portion 16. Here, the refrigerant is subcooled.

The refrigerant flowing out from the subcooling portion 16 of the outdoor heat exchanger 7 enters the refrigerant pipe 13B and flows through the internal heat exchanger 19 to reach the indoor expansion valve 8. In the indoor expansion valve 8, the refrigerant is decompressed and then flows into the heat absorber 9 to evaporate. By the heat absorbing operation at this time, the air blown out from the indoor blower 27 is cooled. Furthermore, the water in the air coagulates to adhere to the heat absorber 9, and hence the air in the air flow passage 3 is dehumidified. The refrigerant evaporated in the heat absorber 9 flows through the internal heat exchanger 19 and the refrigerant pipe 13C to reach the accumulator 12, and flows therethrough to be sucked into the compressor 2, thereby repeating the circulation. At this time, the outdoor expansion valve 6 is shut off, so that it is similarly possible to inhibit or prevent the disadvantage that the refrigerant discharged from the compressor 2 flows from the outdoor expansion valve 6 back into the radiator 4. Consequently, it is possible to inhibit or eliminate the decrease of the amount of the refrigerant to be circulated, and it is possible to acquire the air conditioning capability.

Here, in the above-mentioned cooling mode, the high-temperature refrigerant flows through the radiator 4, and hence direct heat conduction from the radiator 4 to the HVAC unit 10 considerably occurs, but the refrigerant does not flow through the radiator 4 in this MAX cooling mode. Therefore, the air from the heat absorber 9 in the air flow passage 3 is not heated by heat transmitted from the radiator 4 to the HVAC unit 10. Consequently, powerful cooling of the vehicle interior is performed, and especially under an environment where the outdoor air temperature Tam is high, the vehicle interior can rapidly be cooled to achieve the comfortable air conditioning of the vehicle interior. Also in this MAX cooling mode, the controller 32 controls the number of revolution of the compressor 2 on the basis of the temperature of the heat absorber 9 (the heat absorber temperature Te) which is detected by the heat absorber temperature sensor 48 and the target heat absorber temperature TEO that is the target value of the heat absorber temperature.

(6) Switching Between Operation Modes

The air circulated in the air flow passage 3 is subjected to the cooling from the heat absorber 9 and a heating operation from the radiator 4 (and the auxiliary heater 23) (adjusted by the air mix damper 28) in the above respective operation modes, and the air is blown out from the outlet 29 into the vehicle interior. The controller 32 calculates the target outlet temperature TAO on the basis of the outdoor air temperature Tam detected by the outdoor air temperature sensor 33, the temperature of the vehicle interior which is detected by the indoor air temperature sensor 37, the blower voltage, the solar radiation amount detected by the solar radiation sensor 51 and others, and the target vehicle interior temperature (the predetermined temperature) set in the air conditioning operating portion 53. When switching between the operation modes, the controller controls the temperature of the air blown out from the outlet 29 at this target outlet temperature TAO.

In this case, the controller 32 switches between the operation modes on the basis of parameters such as the outdoor air temperature Tam, the humidity of the vehicle interior, the target outlet temperature TAO, the radiator temperature TH, the target radiator temperature TCO, the heat absorber temperature Te, the target heat absorber temperature TEO, and presence/absence of requirement for the dehumidifying of the vehicle interior, to accurately switch between the heating mode, the dehumidifying and heating mode, the dehumidifying and cooling mode, the cooling mode and the MAX cooling mode in accordance with environment conditions or necessity for the dehumidifying, thereby achieving comfortable and efficient air conditioning of the vehicle interior.

(7) Control of Compressor 2 in MAX Cooling Mode by Controller 32

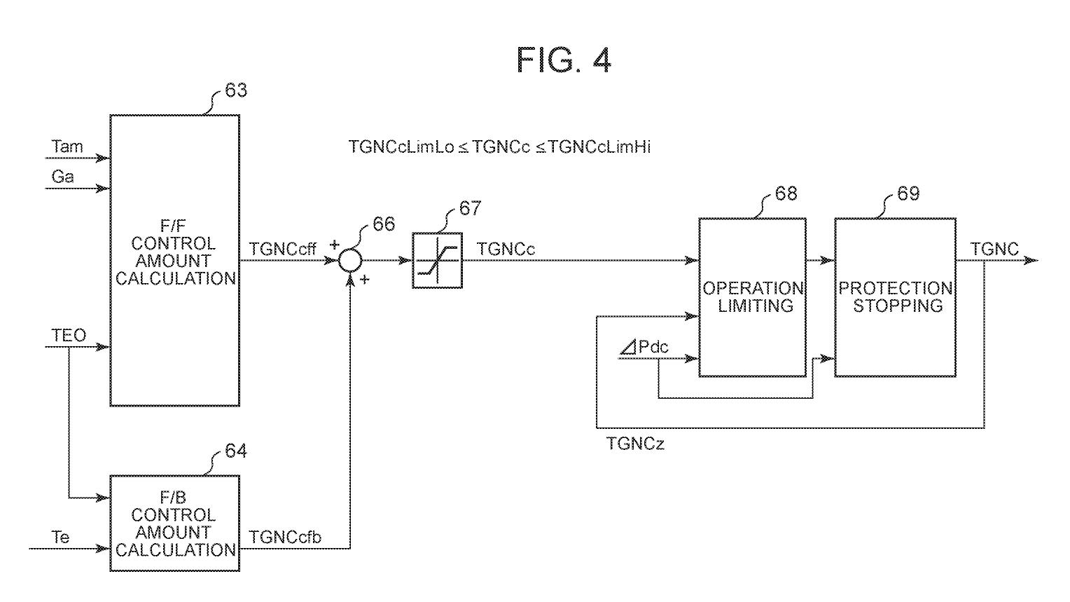

Next, description will be made in detail as to the control of the compressor 2 in the above-mentioned MAX cooling mode with reference to FIG. 4. It is to be noted that the control in the dehumidifying and heating mode is basically similar, but here the description is made by using the MAX cooling mode. FIG. 4 is a control block diagram of the controller 32 which determines a target number of revolution (a compressor target number of revolution) TGNCc of the compressor 2 for the above MAX cooling mode. An F/F control amount calculation section 63 of the controller 32 calculates an F/F control amount TGNCcff of the compressor target number of revolution on the basis of the outdoor air temperature Tam, a mass air volume Ga of the air flowing into the air flow passage 3, and the target heat absorber temperature TEO that is a target value of the temperature (Te) of the heat absorber 9.

Furthermore, an F/B control amount calculation section 64 calculates an F/B control amount TGNCcfb of the compressor target number of revolution on the basis of the target heat absorber temperature TEO and the heat absorber temperature Te. Then, an adder 66 adds the F/F control amount TGNCcff calculated by the F/F control amount calculation section 63 and the F/B control amount TGNCcfb calculated by the F/B control amount calculation section 64, a limit setting section 67 attaches limits of an upper limit of controlling and a lower limit of controlling, and then TGNCc is input as the control amount successively into an operation limiting section 68 and a protection stopping section 69.

The operation limiting section 68 limits the control amount TGNCc input from the limit setting section 67 on the basis of a difference ΔPdc between a pressure on an outlet side of the outdoor expansion valve 6 and a pressure on an inlet side thereof and a control amount TGNCz fed back from the protection stopping section 69, and then, the protection stopping section 69 obtains a control amount to stop the compressor 2. It is to be noted that description will be made later in detail as to a limiting/protecting operation based on the difference ΔPdc between the pressure on the outlet side of the outdoor expansion valve 6 and the pressure on the inlet side thereof by the operation limiting section 68 and the protection stopping section 69. Then, a control amount TGNC output from the protection stopping section 69 is determined as the compressor target number of revolution. In the MAX cooling mode, the controller 32 controls the number of revolution of the compressor 2 on the basis of this compressor target number of revolution TGNC (stopping is included, and this also applies to the dehumidifying and heating mode).

(8) Limiting/Protecting Operation (No. 1) Based on Difference ΔPdc Between Pressure on Outlet Side of Outdoor Expansion Valve 6 and Pressure on Inlet Side Thereof

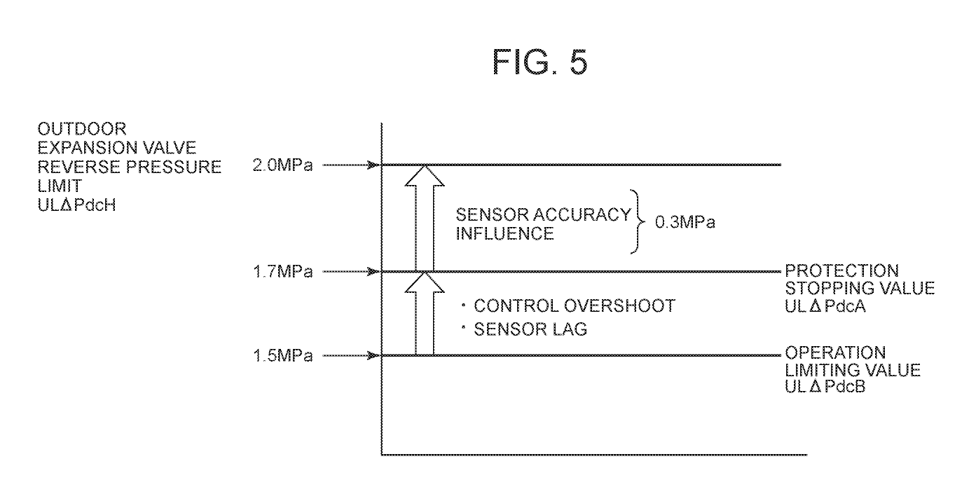

Next, there will be described, with reference to FIG. 5, an example of the above-mentioned limiting/protecting operation based on the difference ΔPdc between the pressure on the outlet side of the outdoor expansion valve 6 and the pressure on the inlet side thereof by the operation limiting section 68 and the protection stopping section 69 of the controller 2. As described above, in the dehumidifying and heating mode and the MAX cooling mode (the modes constitute a second operation mode in the present invention. It is to be noted that the above-mentioned heating mode, dehumidifying and cooling mode and cooling mode constitute a first operation mode in the present invention), the outdoor expansion valve 6 is shut off. However, as described above, there is a predetermined reverse pressure limit ULΔPdcH in the outdoor expansion valve 6, and the pressure on the outlet side of the outdoor expansion valve 6 is higher than that on the inlet side thereof. When the difference is in excess of this reverse pressure limit ULΔPdcH, the shutoff outdoor expansion valve 6 opens, and the refrigerant flows backward into the radiator 4.

To eliminate the problem, when the present operation mode is the dehumidifying and heating mode or the MAX cooling mode that is the second operation mode, the controller 32 limits the number of revolution NC of the compressor 2 or stops the compressor 2 by the operation limiting section 68 and the protection stopping section 69 as described above with reference to FIG. 4, thereby operating so that the difference ΔPdc between the pressure on the outlet side of the outdoor expansion valve 6 and the pressure on the inlet side thereof is not in excess of this reverse pressure limit ULΔPdcH (e.g., 2 MPa).

Specifically, the controller 32 initially calculates the difference ΔPdc (ΔPdc=Pd−PCI) between the pressure on the outlet side of the outdoor expansion valve 6 and the pressure on the inlet side thereof on the basis of the discharge pressure Pd (detected by the discharge pressure sensor 42) which is the pressure on the outlet side of the outdoor expansion valve 6 and the radiator pressure PCI (detected by the radiator pressure sensor 47) which is the pressure on the inlet side of the outdoor expansion valve 6.

On the other hand, in the embodiment, there is set, to the protection stopping section 69 of the controller 32, a protection stopping value ULΔPdcA (1.7 MPa) which is lower than the above-mentioned reverse pressure limit ULΔPdcH as much as a predetermined value (e.g., 0.3 MPa), there is set, to the operation limiting section 68, an operation limiting value ULΔPdcB (1.5 MPa and an example of a target value TGΔPdc to limit the number of revolution NC of the compressor 2) which is further lower than this protection stopping value ULΔPdcA as much as a predetermined value (e.g., 0.2 MPa), and the controller 32 holds these values. It is to be noted that the above predetermined value (0.3 MPa) is a tolerance determined in consideration of influence of accuracy of each of the pressure sensors 42 and 47, and the predetermined value (0.2 MPa) is a tolerance determined in consideration of overshoot of controlling or detection lag of each of the pressure sensors 42 and 47. FIG. 5 shows a relation between the values.

Then, on the basis of the above-mentioned difference ΔPdc (=Pd−PCI) between the pressure on the outlet side of the outdoor expansion valve 6 and the pressure on the inlet side thereof, the operation limiting section 68 of the controller 32 adjusts the above-mentioned operation limiting value ULΔPdcB to the target value TGΔPdc, and feedback-controls the target number of revolution TGNC of the compressor 2 so that the pressure difference ΔPdc is prevented from being more than the operation limiting value ULΔPdcB. Specifically, the controller decreases (limits) the target number of revolution TGNC of the compressor 2 as the pressure difference ΔPdc enlarges to be closer to the operation limiting value ULΔPdcB, and the controller executes the control to inhibit the enlargement of the pressure difference ΔPdc.

Thus, the controller adjusts this operation limiting value ULΔPdcB to the target value TGΔPdc and controls and limits the number of revolution NC, but when the pressure difference ΔPdc still enlarges to be in excess of the operation limiting value ULΔPdcB to become the above-mentioned protection stopping value ULΔPdcA, the protection stopping section 69 of the controller 32 determines that the target number of revolution TGNC of the compressor 2 is 0 (stop). Consequently, the compressor 2 is stopped.

Thus, during the operation in the dehumidifying and heating mode and the MAX cooling mode (the second operation mode), the controller 32 controls the number of revolution NC of the compressor 2 so that the pressure difference ΔPdc is not in excess of the reverse pressure limit ULΔPdcH of the outdoor expansion valve 6, on the basis of the difference ΔPdc between the pressure on the outlet side of the outdoor expansion valve 6 and the pressure on the inlet side thereof. Therefore, in the dehumidifying and heating mode and the MAX cooling mode (the second operation mode) to shut off the outdoor expansion valve 6, it is possible to prevent or inhibit the disadvantage that the difference ΔPdc between the pressure on the outlet side of the outdoor expansion valve 6 and the pressure on the inlet side thereof is in excess of the reverse pressure limit ULΔPdcH of the outdoor expansion valve 6, the outdoor expansion valve 6 opens and the refrigerant flows backward into the radiator 4.

Consequently, in the dehumidifying and heating mode and the MAX cooling mode in which the refrigerant is not sent to the radiator 4, it is possible to previously avoid the disadvantage that a large amount of refrigerant is accumulated in the radiator 4 to decrease the amount of the refrigerant to be circulated and that an air conditioning performance lowers. Furthermore, an operation in a state of being short of oil is also avoidable. Consequently, it is possible to previously prevent the disadvantage that the compressor 2 is damaged, and it is possible to achieve improvement of reliability and comfortability.

Particularly, in this embodiment, there are set, to the controller 32, the predetermined protection stopping value ULΔPdcA which is lower than the reverse pressure limit ULΔPdcH of the outdoor expansion valve 6, and the predetermined operation limiting value ULΔPdcB which is further lower than this protection stopping value ULΔPdcA, and in the dehumidifying and heating mode and the MAX cooling mode, the controller 32 controls the number of revolution NC of the compressor 2 so that the difference ΔPdc between the pressure on the outlet side of the outdoor expansion valve 6 and the pressure on the inlet side thereof is prevented from being more than the operation limiting value ULΔPdcB. Furthermore, when the pressure difference ΔPdc becomes the protection stopping value ULΔPdcA, the controller stops the compressor 2. Consequently, it is possible to accurately prevent or inhibit the disadvantage that the difference ΔPdc between the pressure on the outlet side of the outdoor expansion valve 6 and the pressure on the inlet side thereof is in excess of the reverse pressure limit ULΔPdcH, the outdoor expansion valve 6 opens and the refrigerant flows backward into the radiator 4.

(9) Limiting/Protecting Operation (No. 2) Based on Difference ΔPdc Between Pressure on Outlet Side of Outdoor Expansion Valve 6 and Pressure on Inlet Side Thereof

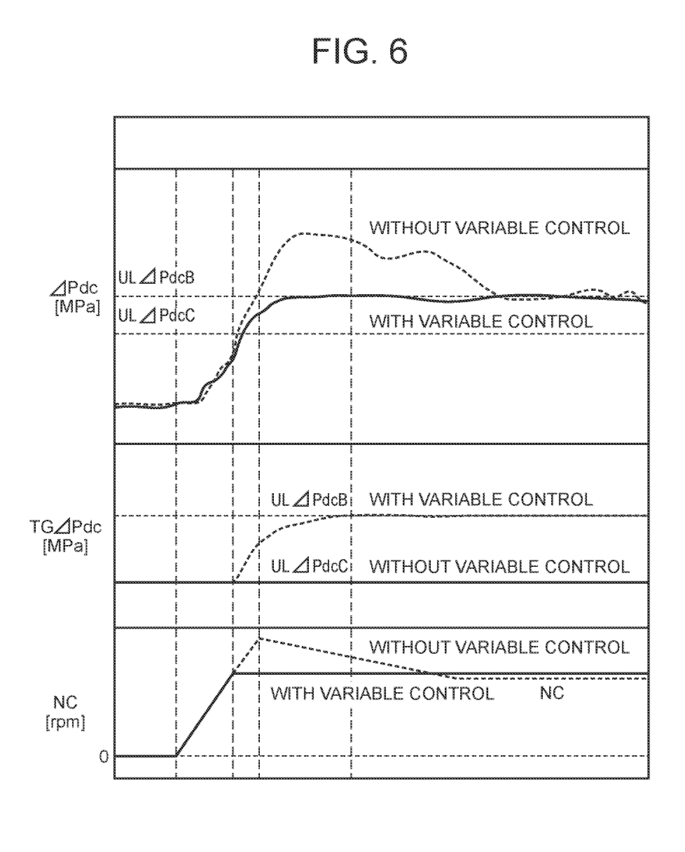

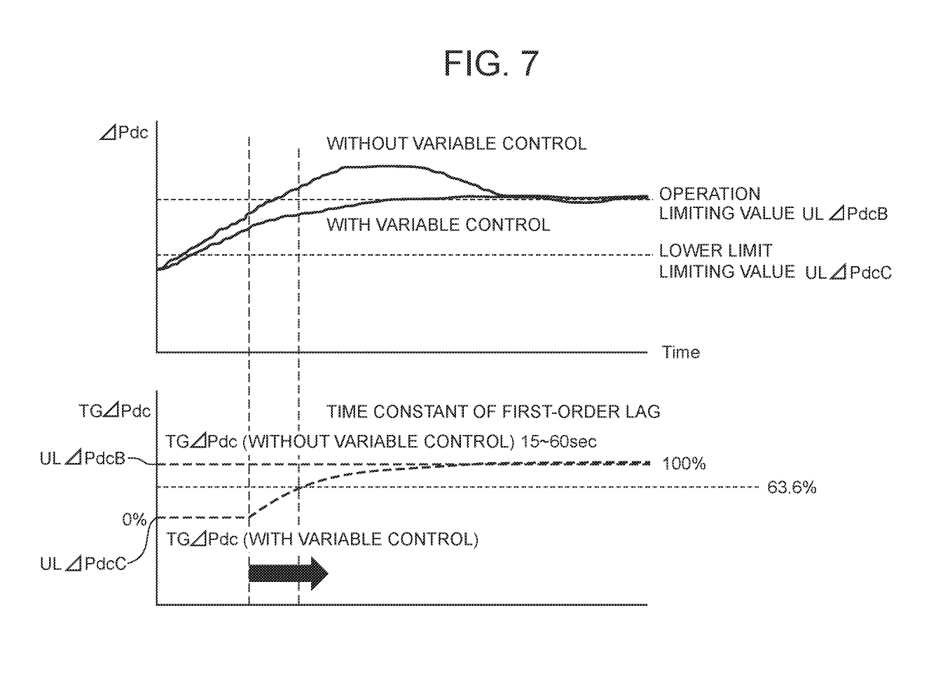

Next, there will be described, with reference to FIG. 6 and FIG. 7, another example of the limiting/protecting operation based on the difference ΔPdc between the pressure on the outlet side of the outdoor expansion valve 6 and the pressure on the inlet side thereof by the operation limiting section 68 and the protection stopping section 69 of the controller 2. In the above-mentioned example, the target value TGΔPdc to limit the number of revolution NC of the compressor 2 is fixed to the operation limiting value ULΔPdcB to limit the number of revolution NC of the compressor 2, but when starting the compressor 2, its number of revolution NC is rapidly increased, and hence the target value TGΔPdc may be variable as described below.

In this case, for example, a lower limit limiting value ULΔPdcC which is further lower than the above-mentioned operation limiting value ULΔPdcB as much as a predetermined value is set to the operation limiting section 68 of the controller 32 (FIG. 6 and FIG. 7). Then, when starting the compressor 2 in the dehumidifying and heating mode and the MAX cooling mode, the controller 32 initially adjusts this lower limit limiting value ULΔPdcC to the target value TGΔPdc, and feedback-controls the target number of revolution TGNC of the compressor 2 so that the difference ΔPdc between the pressure on the outlet side of the outdoor expansion valve 6 and the pressure on the inlet side thereof is prevented from being more than this lower limit limiting value ULΔPdcC. Specifically, the controller decreases (limits) the target number of revolution TGNC of the compressor 2 as the pressure difference ΔPdc enlarges to be closer to the lower limit limiting value ULΔPdcC, and the controller executes the control to inhibit the enlargement of the pressure difference ΔPdc.

Thus, the controller adjusts this lower limit limiting value ULΔPdcC to the target value TGΔPdc and controls and limits the number of revolution NC, but when the pressure difference ΔPdc still enlarges to be in excess of the lower limit limiting value ULΔPdcC, the controller 32 changes the target value TGΔPdc to gradually raise the value toward the operation limiting value ULΔPdcB as shown in a lower stage of FIG. 7. In this case, the controller 32 raises the target value TGΔPdc with a predetermined time constant of first-order lag which is previously determined. The time constant in this case is a value of 15 seconds to 60 seconds of a time required for rise from 0% (the lower limit limiting value ULΔPdcC) to 63.6% of the operation limiting value ULΔPdcB (100%) that is a final value in the example.

Here, in a case that the target value TGΔPdc is fixed to the operation limiting value ULΔPdcB (without variable control), the number of revolution NC is also rapidly increased as shown by a broken line in a lowermost stage of FIG. 6 when starting the compressor 2. Therefore, as shown by a broken line in an uppermost stage of FIG. 6 and as shown by an upper solid line in an upper stage of FIG. 7, the pressure difference ΔPdc is much larger than the operation limiting value ULΔPdcB. That is, so-called overshoot occurs.

On the other hand, as in this example, when starting the compressor 2, the target value TGΔPdc of the pressure difference ΔPdc which limits the number of revolution NC of the compressor 2 is initially adjusted to the lower limit limiting value ULΔPdcC which is lower than the operation limiting value ULΔPdcB. The controller controls the number of revolution NC of the compressor 2 so that the pressure difference ΔPdc is prevented from being more than the lower limit limiting value ULΔPdcC. However, when the pressure difference ΔPdc is in excess of the lower limit limiting value ULΔPdcC, the controller gradually raises the target value TGΔPdc toward the operation limiting value ULΔPdcB (with the variable control). Consequently, the number of revolution NC of the compressor 2 is limited in an earlier stage, and the overshoot is eliminated or inhibited as shown by a solid line in the lowermost stage of FIG. 6. Therefore, as shown by a solid line in the uppermost stage of FIG. 6 and as shown by a lower solid line in the upper stage of FIG. 7, the pressure difference ΔPdc gently comes close to the operation limiting value ULPdcB from the downside.

It is to be noted that afterward, when the pressure difference ΔPdc still enlarges to become the above-mentioned protection stopping value ULΔPdcA, the protection stopping section 69 of the controller 32 similarly determines that the target number of revolution TGNC of the compressor 2 is 0 (stop). In consequence, the compressor 2 is stopped.

Thus, there is set the lower limit limiting value ULΔPdcC which is further lower than the operation limiting value ULΔPdcB, and when starting the dehumidifying and heating mode and the MAX cooling mode (the second operation mode), the controller 32 controls the number of revolution NC of the compressor 2 so that the difference ΔPdc between the pressure on the outlet side of the outdoor expansion valve 6 and the pressure on the inlet side thereof is prevented from being more than the lower limit limiting value ULΔPdcC. Furthermore, when the pressure difference ΔPdc is in excess of the lower limit limiting value ULΔPdcC, the controller gradually raises the lower limit limiting value ULΔPdcC toward the operation limiting value ULΔPdcB. Consequently, it is possible to previously avoid the disadvantage that the pressure difference ΔPdc enlarges due to the so-called overshoot, and it is possible to further securely prevent the backflow of the refrigerant into the radiator 4.

In particular, as in the example, when changing the lower limit limiting value ULΔPdcC to the operation limiting value ULΔPdcB, the controller 32 raises the value with the predetermined time constant of first-order lag which is previously determined. Consequently, it is possible to further accurately eliminate the occurrence of the overshoot.

(10) Limiting/Protecting Operation (No. 3) Based on Difference ΔPdc Between Pressure on Outlet Side of Outdoor Expansion Valve 6 and Pressure on Inlet Side Thereof

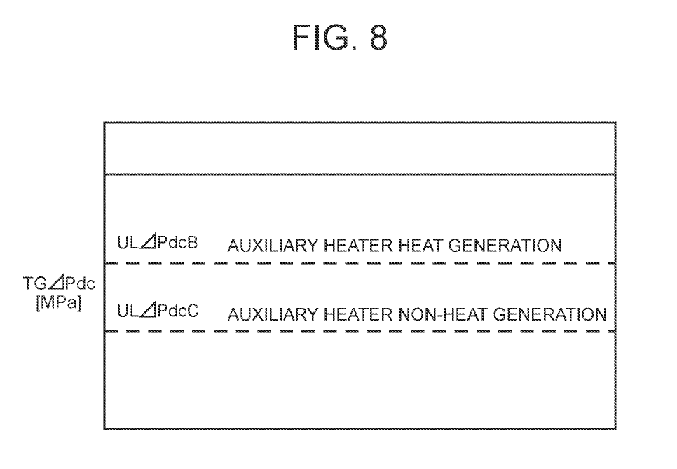

Next, there will be described, with reference to FIG. 8, still another example of the limiting/protecting operation based on the difference ΔPdc between the pressure on the outlet side of the outdoor expansion valve 6 and the pressure on the inlet side thereof by the operation limiting section 68 and the protection stopping section 69 of the controller 2. In the above-mentioned example, when starting the compressor 2 in the dehumidifying and heating mode and the MAX cooling mode, the controller 32 initially adjusts this lower limit limiting value ULΔPdcC to the target value TGΔPdc, and limits and controls the number of revolution NC of the compressor 2 so that the difference ΔPdc between the pressure on the outlet side of the outdoor expansion valve 6 and the pressure on the inlet side thereof is prevented from being more than the lower limit limiting value ULΔPdcC. When the pressure difference ΔPdc still enlarges to be in excess of the lower limit limiting value ULΔPdcC, the controller gradually changes the target value TGΔPdc toward the operation limiting value ULΔPdcB, but the target value TGΔPdc may vary in the dehumidifying and heating mode and the MAX cooling mode.

In this case, when starting the compressor 2 in the dehumidifying and heating mode, the controller adjusts the target value TGΔPdc to the operation limiting value ULΔPdcB, and limits and controls the number of revolution NC of the compressor 2 so that the difference ΔPdc between the pressure on the outlet side of the outdoor expansion valve 6 and the pressure on the inlet side thereof is prevented from being more than this operation limiting value ULΔPdcB, and when starting the compressor 2 in the MAX cooling mode, the controller adjusts the target value TGΔPdc to the lower limit limiting value ULΔPdcC, and limits and controls the number of revolution NC of the compressor 2 so that the difference ΔPdc between the pressure on the outlet side of the outdoor expansion valve 6 and the pressure on the inlet side thereof is prevented from being more than this lower limit limiting value ULΔPdcC.

Here, in the dehumidifying and heating mode, the controller starts the compressor 2 while generating heat in the auxiliary heater 23 as described above, and hence the air heated by the auxiliary heater 23 flows into the radiator 4, thereby raising the radiator pressure PCI. Therefore, the difference ΔPdc (ΔPdc=Pd−PCI) between the pressure on the outlet side of the outdoor expansion valve 6 and the pressure on the inlet side thereof is reduced. Therefore, also when the target value TGΔPdc is lowered to the lower limit limiting value ULΔPdcC as described above, the number of revolution NC of the compressor 2 is sufficiently acquired, a dehumidifying and heating capability is maintained, and the backflow of the refrigerant into the radiator 4 is also securely prevented.

On the other hand, the auxiliary heater 23 does not generate heat in the MAX cooling mode as described above, the temperature of the radiator 4 therefore lowers, and the pressure difference ΔPdc tends to enlarge. In this case, when the target value TGΔPdc is low, there is a risk that the number of revolution NC of the compressor 2 is limited more than necessary and that a cooling capability noticeably lowers. To eliminate the problem, as described above in the MAX cooling mode, the target value TGΔPdc is adjusted to the comparatively high operation limiting value ULΔPdcB to inhibit the limiting of the number of revolution NC of the compressor 2, and the deterioration of the comfortability due to the lowering of the cooling capability in the vehicle interior is prevented.

It is to be noted that also in this case, when starting the dehumidifying and heating mode, the controller 32 adjusts the lower limit limiting value ULΔPdcC to the target value TGΔPdc and limits and controls the number of revolution NC, but when the pressure difference ΔPdc still enlarges to be in excess of the lower limit limiting value ULΔPdcC, the controller changes the target value TGΔPdc to gradually raise the value toward the operation limiting value ULΔPdcB. Furthermore, afterward, when the pressure difference ΔPdc still enlarges to become the protection stopping value ULΔPdcA, the protection stopping section 69 of the controller 32 similarly determines that the target number of revolution TGNC of the compressor 2 is 0 (stop). Consequently, the compressor 2 is stopped.

(11) Control Example in Case of Starting Compressor 2 in MAX Cooling Mode

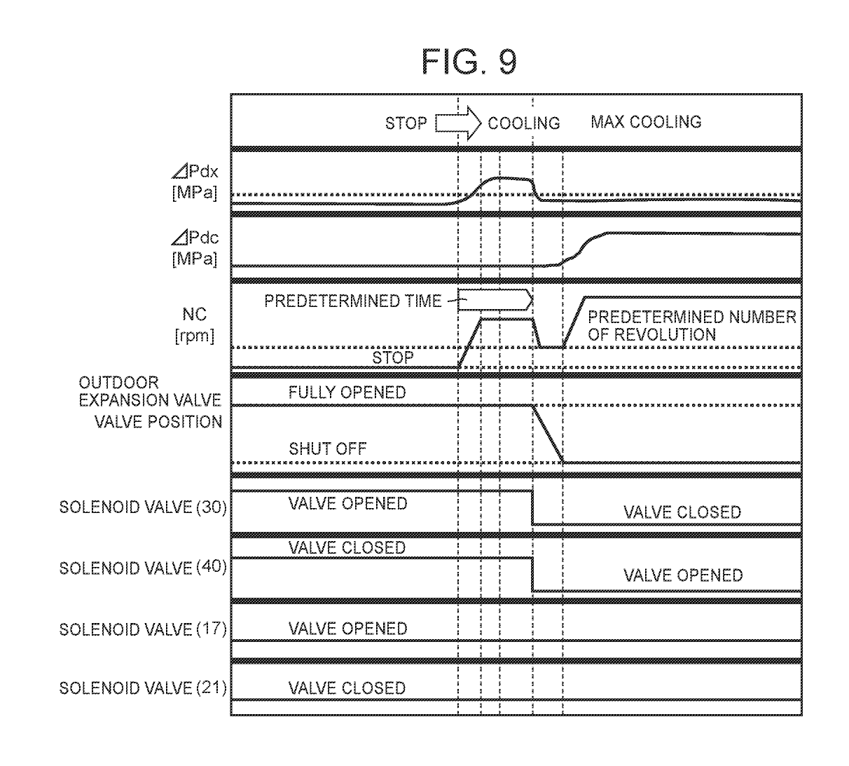

Next, description will be made, with reference to FIG. 9, as to an example of control by the controller 2 when starting in the MAX cooling mode. In this example, when starting the compressor 2 in the MAX cooling mode, the controller 32 initially starts in the cooling mode of the operation mode. FIG. 9 shows states of the respective components in this case. It is to be noted that in the drawing, ΔPdx indicates a difference between a pressure before the solenoid valve 40 and a pressure after the solenoid valve, the difference being obtained from a difference between the discharge pressure Pd detected by the discharge pressure sensor 42 and a pressure of the outdoor heat exchanger 7 which is converted from a temperature of the outdoor heat exchanger 7 detected by the outdoor heat exchanger temperature sensor 54 (or the pressure of the outdoor heat exchanger 7 which is detected by the outdoor heat exchanger pressure sensor 56). In the drawing, ΔPdc indicates the difference between the pressure on the outlet side of the outdoor expansion valve 6 and the pressure on the inlet side thereof (it is also a difference between a pressure before the solenoid valve 30 and a pressure after the solenoid valve), the difference being similarly obtained from the discharge pressure Pd and the radiator pressure PCI. Furthermore, NC indicates the number of revolution of the compressor 2.

As shown in FIG. 9, when selecting the MAX cooling mode on startup, the controller 32 initially starts the compressor 2 (opens the solenoid valve 30 and closes the solenoid valve 40) in the cooling mode. Afterward, when a predetermined time (e.g., about one minute) elapses, the controller changes the respective solenoid valves 30 and 40 to the MAX cooling mode (closes the solenoid valve 30 and opens the solenoid valve 40), once lowers the number of revolution NC of the compressor 2 to the predetermined number of revolution, shuts off the outdoor expansion valve 6, and then shifts to the control of the compressor 2 in the MAX cooling mode.

As described above, the refrigerant flows backward into the radiator 4 due to the difference ΔPdc between the pressure on the outlet side of the outdoor expansion valve 6 and the pressure on the inlet side thereof. Therefore, also when the controller limits the number of revolution NC of the compressor 2 as described above, there is a risk that the refrigerant is laid up for a long time in the radiator 4 during the operation in the MAX cooling mode. However, when the controller starts in the cooling mode on startup as in this example, the refrigerant flows through the radiator 4 as described above, and hence the refrigerant and oil accumulated and laid up for a long time in the radiator 4 can be expelled.

Specifically, a refrigerant scavenging operation is performed in this cooling mode, and hence it is possible to effectively eliminate the lowering of the air conditioning capability due to decrease of an amount of the refrigerant to be circulated through the refrigerant circuit R, burning of the compressor 2 due to decrease of an amount of the oil to be returned, and the like. It is to be noted that the controller 32 executes the operation in the cooling mode (the refrigerant scavenging operation) as described above for a predetermined time, and then ends the refrigerant scavenging operation to change to the MAX cooling mode, thereby also minimizing the deterioration of the comfortability of the vehicle interior by the refrigerant scavenging operation when starting the compressor 2 or when selecting the MAX cooling mode.

It is to be noted that the present invention is not limited to the above example. Also when starting the compressor 2 in the dehumidifying and heating mode, the compressor is started in the heating mode or the dehumidifying and cooling mode, and then the mode is changed to the dehumidifying and heating mode, so that it is possible to expel the refrigerant or oil laid up for a long time in the radiator 4 in the dehumidifying and heating mode.

Furthermore, in the embodiment, the heating mode, the dehumidifying and cooling mode and the cooling mode are executed as the first operation mode, and the dehumidifying and heating mode and the MAX cooling mode are executed as the second operation mode, but the present invention is not limited to this embodiment. The present invention is also effective for a vehicle air conditioner to execute one or any combination of a heating mode, a dehumidifying and cooling mode and a cooling mode as a first operation mode, and to execute one of a dehumidifying and heating mode and a MAX cooling mode as a second operation mode.

Furthermore, the switching control between the operation modes described in the embodiment is not limited thereto, and appropriate conditions may be set by employing one, any combination or all of parameters such as the outdoor air temperature Tam, the humidity of the vehicle interior, the target outlet temperature TAO, the radiator temperature TH, the target radiator temperature TCO, the heat absorber temperature Te, the target heat absorber temperature TEO, and the presence/absence of the requirement for the dehumidifying of the vehicle interior, in accordance with the capability and use environment of the vehicle air conditioner.

Additionally, the auxiliary heating device is not limited to the auxiliary heater 23 described in the embodiment, and a heating medium circulating circuit which circulates a heating medium heated by a heater to heat air in an air flow passage, a heater core which circulates radiator water heated by an engine or the like may be utilized. In addition, the solenoid valve 30 and the solenoid valve 40 described in the embodiment may be constituted of a three way valve (the flow channel changing device) disposed in a branching portion of the bypass pipe 35, to switch between a state of sending, to the radiator 4, the refrigerant discharged from the compressor 2 and a state of sending the refrigerant to the bypass pipe 35. Specifically, the constitutions of the refrigerant circuit R which are described in the above respective embodiments are not limited thereto, and needless to say, the constitutions are changeable without departing from the gist of the present invention.

### DESCRIPTION OF REFERENCE NUMERALS

1 vehicle air conditioner
2 compressor
3 air flow passage
4 radiator
6 outdoor expansion valve
7 outdoor heat exchanger
8 indoor expansion valve
9 heat absorber
23 auxiliary heater (an auxiliary heating device)
27 indoor blower (a blower fan)
28 air mix damper
30 and 40 solenoid valve (a flow channel changing device)
31 outlet changing damper
32 controller (a control device)
35 bypass pipe
45 bypass device
R refrigerant circuit

1. A vehicle air conditioner comprising:
a compressor to compress a refrigerant,
an air flow passage through which air to be supplied to a vehicle interior flows,
a radiator to let the refrigerant radiate heat, thereby heating the air to be supplied from the air flow passage to the vehicle interior,
a heat absorber to let the refrigerant absorb heat, thereby cooling the air to be supplied from the air flow passage to the vehicle interior,
an outdoor heat exchanger disposed outside the vehicle interior,
an outdoor expansion valve to decompress the refrigerant flowing out from the radiator and flowing into the outdoor heat exchanger,
a bypass device to send, to the outdoor heat exchanger, the refrigerant discharged from the compressor, passing the radiator and the outdoor expansion valve, and
a control device,
so that the control device switches between and executes a first operation mode to send, to the radiator, the refrigerant discharged from the compressor, and a second operation mode to shut off the outdoor expansion valve and send, directly into the outdoor heat exchanger, the refrigerant discharged from the compressor, passing the radiator and the outdoor expansion valve by the bypass device,
wherein in the second operation mode, on the basis of a difference ΔPdc between a pressure on an outlet side of the outdoor expansion valve and a pressure on an inlet side thereof, the control device controls a number of revolution of the compressor so that the pressure difference ΔPdc is not in excess of a predetermined reverse pressure limit ULΔPdcH of the outdoor expansion valve.

2. The vehicle air conditioner according to claim 1, wherein the control device has a predetermined protection stopping value ULΔPdcA which is lower than the reverse pressure limit ULΔPdcH of the outdoor expansion valve, and a predetermined operation limiting value ULΔPdcB which is further lower than this protection stopping value ULΔPdcA,
in the second operation mode, the control device controls the number of revolution of the compressor so that the difference ΔPdc between the pressure on the outlet side of the outdoor expansion valve and the pressure on the inlet side thereof is prevented from being more than the operation limiting value ULΔPdcB, and
when the pressure difference ΔPdc becomes the protection stopping value ULΔPdcA, the control device stops the compressor.

3. The vehicle air conditioner according to claim 2, wherein the control device has a predetermined lower limit limiting value ULΔPdcC which is further lower than the operation limiting value ULΔPdcB,
when starting the second operation mode, the control device controls the number of revolution of the compressor so that the difference ΔPdc between the pressure on the outlet side of the outdoor expansion valve and the pressure on the inlet side thereof is prevented from being more than the lower limit limiting value ULΔPdcC, and
when the pressure difference ΔPdc is in excess of the lower limit limiting value ULΔPdcC, the control device gradually raises the lower limit limiting value ULΔPdcC toward the operation limiting value ULΔPdcB.

4. The vehicle air conditioner according to claim 3, wherein when changing the lower limit limiting value ULΔPdcC to the operation limiting value ULΔPdcB, the control device raises the value with a predetermined time constant of first-order lag which is previously determined.

5. The vehicle air conditioner according to claim 2, comprising an auxiliary heating device to heat the air to be supplied from the air flow passage to the vehicle interior,
wherein the control device has a predetermined lower limit limiting value ULΔPdcC which is further lower than the operation limiting value ULΔPdcB,
when starting the second operation mode while generating heat in the auxiliary heating device, the control device controls the number of revolution of the compressor so that the difference ΔPdc between the pressure on the outlet side of the outdoor expansion valve and the pressure on the inlet side thereof is prevented from being more than the lower limit limiting value ULΔPdcC, and
when starting the second operation mode without generating heat in the auxiliary heating device, the control device controls the number of revolution of the compressor so that the difference ΔPdc between the pressure on the outlet side of the outdoor expansion valve and the pressure on the inlet side thereof is prevented from being more than the operation limiting value ULΔPdcB.

6. The vehicle air conditioner according to claim 1, comprising an auxiliary heating device to heat the air to be supplied from the air flow passage to the vehicle interior,
wherein the control device has, as the first operation mode, one, any combination or all of:
a heating mode to send, to the radiator, the refrigerant discharged from the compressor, let the refrigerant radiate heat, decompress, in the outdoor expansion valve, the refrigerant from which the heat has been radiated, and let the refrigerant absorb heat in the outdoor heat exchanger,
a dehumidifying and cooling mode to send, from the radiator to the outdoor heat exchanger, the refrigerant discharged from the compressor, let the refrigerant radiate heat in the radiator and the outdoor heat exchanger, decompress the refrigerant from which the heat has been radiated, and then let the refrigerant absorb heat in the heat absorber, and
a cooling mode to send, from the radiator to the outdoor heat exchanger, the refrigerant discharged from the compressor, let the refrigerant radiate heat in the outdoor heat exchanger, decompress the refrigerant from which the heat has been radiated, and then let the refrigerant absorb heat in the heat absorber, and
the control device has, as the second operation mode, one or both of:
a dehumidifying and heating mode to send, to the outdoor heat exchanger, the refrigerant discharged from the compressor, by the bypass device, let the refrigerant radiate heat, decompress the refrigerant from which the heat has been radiated, let the refrigerant absorb heat in the heat absorber, and generate heat in the auxiliary heating device, and
a maximum cooling mode to send, to the outdoor heat exchanger, the refrigerant discharged from the compressor, by the bypass device, let the refrigerant radiate heat, decompress the refrigerant from which the heat has been radiated, and let the refrigerant absorb heat in the heat absorber.
